(19) United States
(12) Patent Application Publication
(10) Pub. No.: US 2008/0204448 A1
(43) Pub. Date: Aug. 28, 2008

(54) UNSOLICITED ADVERTISEMENTS IN A VIRTUAL UNIVERSE THROUGH AVATAR TRANSPORT OFFERS

(76) Inventors: Christopher J. Dawson, Arlington, VA (US); Carl P. Gusler, Austin, TX (US); Rick A. Hamilton, Charlottesville, VA (US); Clifford A. Pickover, Yorktown Heights, NY (US)

Correspondence Address: HOFFMAN WARNICK LLC, 75 STATE ST, 14TH FLOOR, ALBANY, NY, 12207, US

(21) Appl. No.: 11/679,384

(22) Filed: Feb. 27, 2007

(51) Int. Cl. G06T 15/00

(52) U.S. Cl. 345/419

(57) ABSTRACT

A tool is provided that provides unsolicited advertisements in a virtual universe through avatar transport offers. An information collector component is configured to collect information on an avatar that is online in the virtual universe. A transport offer generator component is configured to present an offer to transport the avatar to another region within the virtual universe for exposure to the unsolicited advertisement.

### BACKGROUND

This disclosure relates generally to virtual universes, and more specifically to making unsolicited advertisements to avatars that exist in these virtual universes through transport offers to commercial regions within the virtual universes.

Virtual universes or virtual worlds are computer-based simulated environments intended for its users to inhabit and interact via avatars. Avatars are person as or representations of the users of the virtual universes and generally take the form of two-dimensional or three-dimensional human or fantastical representations of a person's self. These types of virtual universes are now most common in massively multiplayer online games such as Second Life which is a trademark of Linden Lab in the United States, other countries or both. Avatars in these types of virtual universes, which can number well over a million, have a wide range of business and social experiences. These avatars create, manipulate and buy and sell every aspect of their virtual lives. It is common in some of these virtual universes to exchange millions of US dollars on a monthly basis in support of these virtual experiences. As a result, these virtual universes provide a fertile ground for advertising goods and services, whether real-life or virtual, to the avatars that exist in these virtual universes. Currently, advertising for goods and services occurs in these virtual universes through conventional methods and mechanisms (i.e., billboards, posters, flyers, etc.). As the marketing power of these virtual universes becomes more apparent to businesses, it will become desirable to develop other approaches of providing advertisements to avatars in these virtual universes.

### SUMMARY

In one embodiment, there is a method for generating an offer of transport to an avatar that is online in a virtual universe for exposure to an unsolicited advertisement. In this embodiment, the method comprises: collecting information on the avatar; and presenting an offer to transport the avatar to another region within the virtual universe for exposure to the unsolicited advertisement.

In a second embodiment, there is an advertising generation tool for use in a virtual universe. In this embodiment, the tool comprises an information collector component configured to collect information on an avatar that is online in the virtual universe. A transport offer generator component is configured to present an offer to transport the avatar to another region within the virtual universe for exposure to the unsolicited advertisement.

In a third embodiment, there is a computer-readable medium storing computer instructions, which when executed, enables a computer system to generate an offer of transport to an avatar that is online in a virtual universe for exposure to an unsolicited advertisement. In this embodiment, the computer instructions comprises collecting information on the avatar; and presenting an offer to transport the avatar to another region within the virtual universe for exposure to the unsolicited advertisement.

In a fourth embodiment, there is a method for exposing an avatar within a virtual universe with an unsolicited advertisement. In this embodiment, the method comprises: finding an avatar that is online in the virtual universe; and presenting an offer to transport the avatar to another region within the virtual universe for exposure to the unsolicited advertisement.

In a fifth embodiment, there is a computer-readable medium storing computer instructions, which when executed, enables a computer system to generate an offer of transport to an avatar that is online in a virtual universe for exposure to an unsolicited advertisement. In this embodiment, the computer instructions comprises collecting information on the avatar; evaluating whether the collected avatar information warrants targeting the avatar for the unsolicited advertisement; and presenting an offer to transport the avatar to another region within the virtual universe for exposure to the unsolicited advertisement.

In a fifth embodiment, there is a method for deploying an advertising generation tool for use in a computer system that generates unsolicited advertisements in a virtual universe. In this embodiment, a computer infrastructure is provided and is operable to collect information on an avatar that is online in the virtual universe; and present an offer to transport the avatar to another region within the virtual universe for exposure to the unsolicited advertisement.

Therefore, this disclosure provides a method, tool, and computer-readable medium for generating an offer of transport to an avatar that is online in a virtual universe for exposure to an unsolicited advertisement.

### BRIEF DESCRIPTION OF THE DRAWINGS

FIG. 1 shows a high-level schematic diagram showing a networking environment for providing a virtual universe according to one embodiment of this disclosure;

FIG. 2 shows a more detailed view of a virtual region shown in the virtual universe of FIG. 1;

FIG. 3 shows a more detailed view of the virtual universe client shown in FIG. 1;

FIG. 4 shows a more detailed view of some the functionalities provided by the server array shown in FIG. 1;

FIG. 5 shows an advertising generation tool according to one embodiment of this disclosure that operates in the environment shown in FIG. 1;

FIG. 6 shows an example of a commercial region within the virtual universe that an avatar can be transported to for exposure to an unsolicited advertisement; and

FIG. 7 shows a schematic of an exemplary computing environment in which elements of the networking environment shown in FIG. 1 may operate.

### DETAILED DESCRIPTION

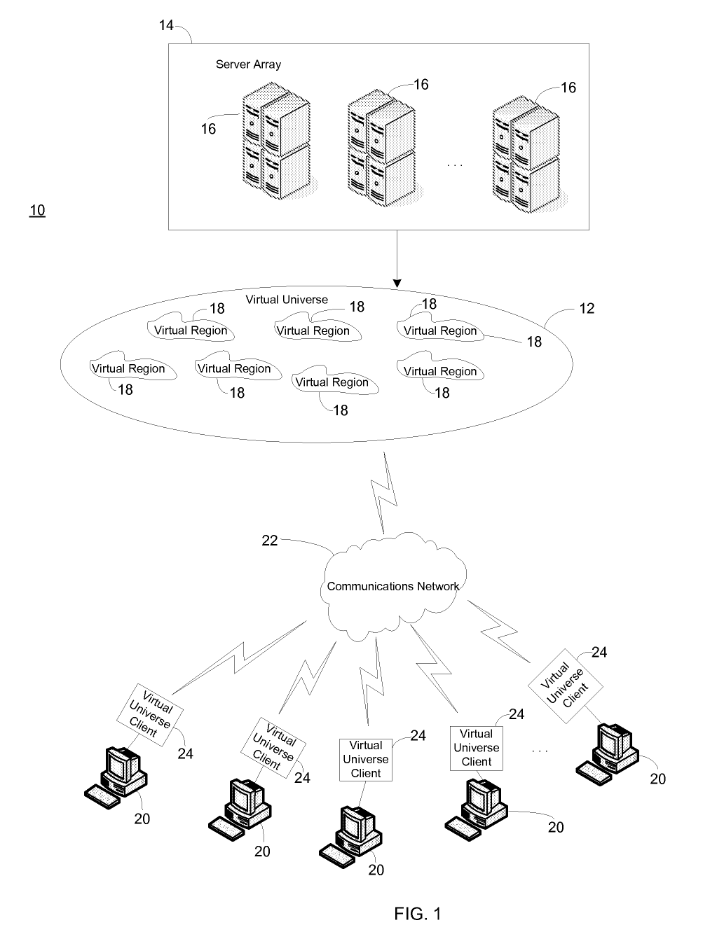

FIG. 1 shows a high-level schematic diagram showing a networking environment 10 for providing a virtual universe 12 according to one embodiment of this disclosure. As shown in FIG. 1, the networking environment 10 comprises a server array or grid 14 comprising a plurality of servers 16 each responsible for managing a sliver of virtual real estate within the virtual universe 12. A virtual universe provided by a typical massively multiplayer online game can employ thousands of servers to manage all of the virtual real estate. The content of the virtual real estate that is managed by each of the servers 16 within the server array 14 shows up in the virtual universe 12 as a virtual region 18. Like the real-world, each virtual region 18 within the virtual universe 12 comprises a living landscape having things such as buildings, stores, clubs, sporting arenas, cities and towns all created by residents of the universe that are represented by avatars. These examples of items are only illustrative of some things that may be found in a virtual region and are not limiting. Furthermore, the number of virtual regions 18 shown in FIG. 1 is only for illustration purposes and those skilled in the art will recognize that there may be many more regions found in a typical virtual universe. FIG. 1 also shows that users operating computers 20 interact with the virtual universe 12 through a communication network 22 via a virtual universe client 24 that resides in the computer. Below are further details of the virtual universe 12, server array 14, and virtual universe client 24.

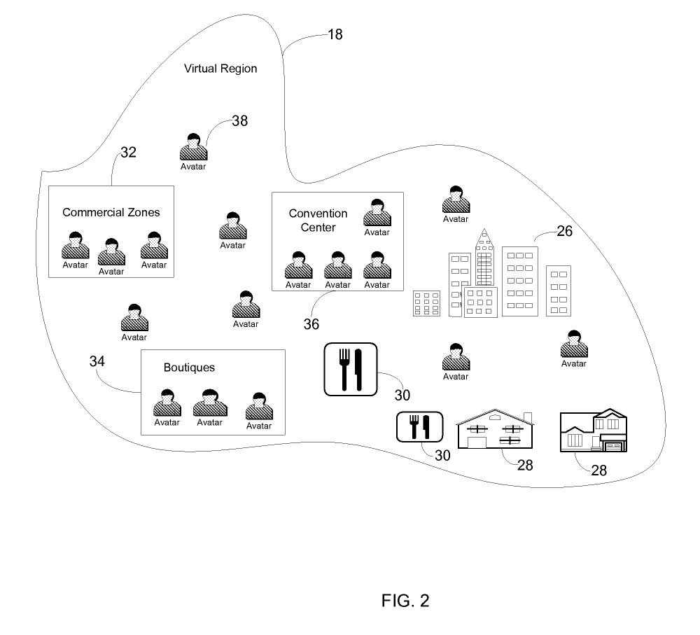

FIG. 2 shows a more detailed view of what one virtual region 18 shown in the virtual universe 12 of FIG. 1 may comprise. As an example, the virtual region 18 shown in FIG. 2 comprises a downtown office center 26, homes 28, restaurants 30 commercial zones 32 and boutiques 34 for shopping and a convention center 36 for meetings and various conventions. Residents or avatars 38, which as mentioned above, are person as or representations of the users of the virtual universe, roam all about the virtual region by walking, driving, flying or even by teleportation or transportation which is essentially moving through space from one point to another, more or less instantaneously. These examples of items in the virtual region 18 shown in FIG. 2 are only illustrative of some things that may be found in a virtual region and those skilled in the art will recognize that these regions can have many more items that can be found in a real-life universe as well as things that do not presently exist in real life.

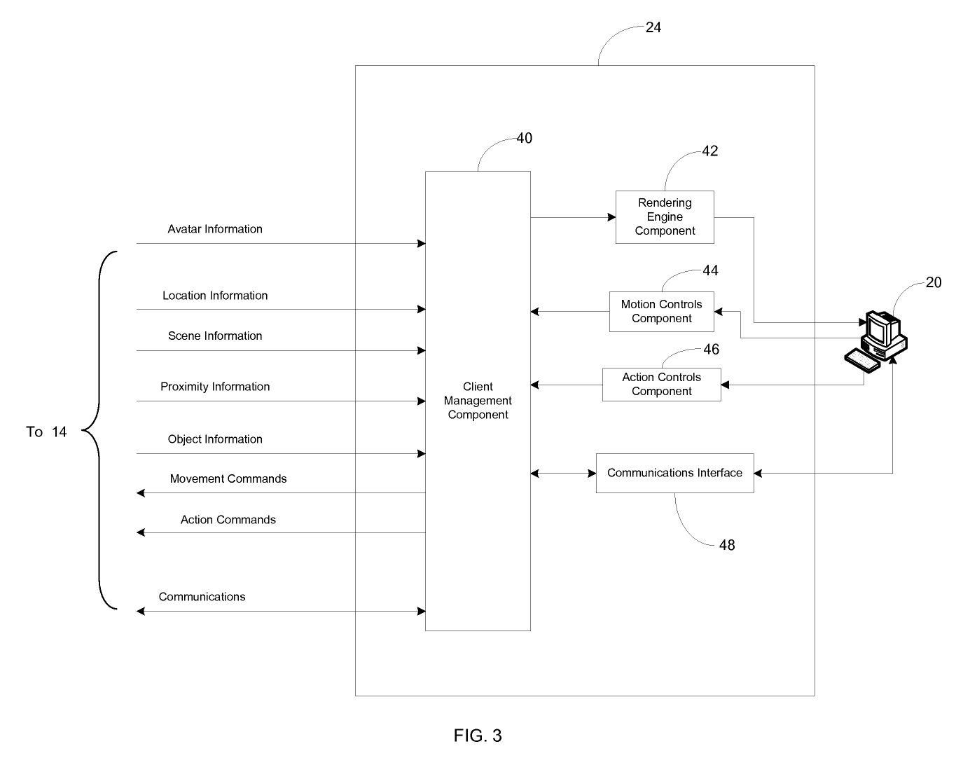

FIG. 3 shows a more detailed view of the virtual universe client 24 shown in FIG. 1. The virtual universe client 24, which enables users to interact with the virtual universe 12, comprises a client management component 40, which manages actions, movements and communications made by a user through computer 20, and information received from the virtual universe through the server array 14. A rendering engine component 42 enables the user of the computer 20 to visualize his or her avatar within the surroundings of the particular region of the virtual universe 12 that it is presently located. A motion controls component 44 enables the user to make movements through the virtual universe. In one embodiment, movements through the virtual universe can include for example, walking, running, driving, flying, etc. An action controls component 46 enables the user to perform actions in the virtual universe such as buying items for his or her avatar or even for their real-life selves, building homes, planting gardens, etc., as well as changing the appearance of their avatar. These actions are only illustrative of some possible actions that a user can perform in the virtual universe and are not limiting of the many possible actions that can be performed. A communications interface 48 enables a user to communicate with other users of the virtual universe 12 through modalities such as chatting, instant messaging, gesturing, and electronic mail (e-mail).

FIG. 3 shows the various types of information received by the client management component 40 from the virtual universe through the server array 14. In particular, the client management component 40 receives avatar information about the avatars that are in proximity to the user's avatar. In addition, the client management component 40 receives location information about the area that the user's avatar is near (e.g., where he or she is) as well as scene information (e.g., what the avatar sees). The client management component 40 also receives proximity information which contains information on what the user's avatar is near and object information which is information that can be obtained by one's senses (e.g., touch, taste, smell, etc.,) and what actions are possible for nearby objects (e.g., copy, purchase, etc.). FIG. 3 also shows the movement commands and action commands that are generated by the user are sent to the server array via the client management component 40, as well as the communications that can be sent to the users of other avatars within the virtual universe.

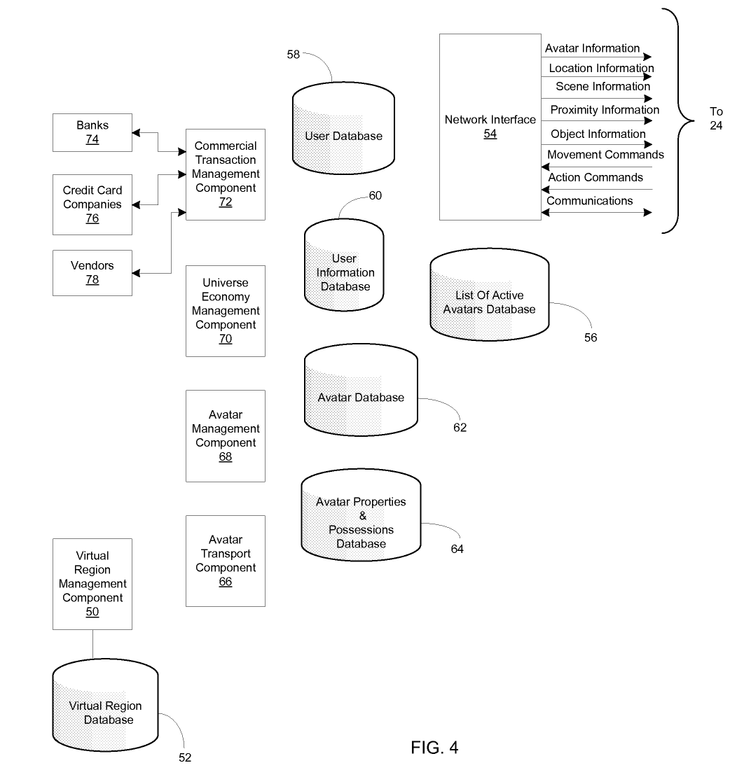

FIG. 4 shows a more detailed view of some the functionalities provided by the server array 14 shown in FIG. 1. In particular, FIG. 4 shows a virtual region management component 50 that manages a virtual region within the virtual universe. In particular, the virtual region management component 50 manages what happens in a particular region such as the type of landscape in that region, the amount of homes, commercial zones, boutiques, streets, parks, restaurants, etc. Those skilled in the art will recognize that the virtual region management component 50 can manage many other items within the virtual region. A virtual region database 52 stores information on all of the items in the virtual region 18 that the virtual region management component 50 is managing. In one embodiment, for very large virtual universes, one server 16 may be responsible for managing one particular virtual region 18 within the universe.

FIG. 4 shows a network interface 54 that enables the server array 14 to interact with the virtual universe client 24 residing on computer 20. In particular, the network interface 54 communicates avatar, location, scene, proximity and object information to the user through the virtual universe client 24 and receives movement and action commands as well as communications from the user via the universe client.

As shown in FIG. 4, there are several different databases for storing information. In particular, database 56 contains a list of all the avatars that are online in the virtual universe 12. Databases 58 and 60 contain information on the actual human users of the virtual universe 12. In one embodiment, database 58 contains general information on the users such as names, addresses, interests, ages, etc., while database 60 contains more private information on the users such as email addresses, billing information (e.g., credit card information) for taking part in transactions. Databases 62 and 64 contain information on the avatars of the users that reside in the virtual universe 12. In one embodiment, database 62 contains information such as all of the avatars that a user may have, the profile of each avatar, while database 64 contains a listing of properties and possessions that each avatar owns such as houses, cars, sporting equipment, appearance, attire, etc. Those skilled in the art will recognize that databases 58-64 may contain additional information if desired. Although the above information is shown in FIG. 4 as being stored in databases, those skilled in the art will recognize that other means of storing information can be utilized.

An avatar transport component 66 enables users to transport, which as mentioned above, allows avatars to transport through space from one point to another point, instantaneously. As a result, an avatar could for example go from New York City to the Chilean Tierra del Fuego to trek the Dientes Circuit or to leave an Australian Rules Football game to go shopping in a mall in Buenos Aires, Argentina.

An avatar management component 68 keeps track of what online avatars are doing while in the virtual universe. For example, the avatar management component 68 can track where the avatar presently is in the virtual universe, what activities it is performing or has recently performed. An illustrative but non-exhaustive list of activities can include shopping, eating, talking, recreating, etc.

Because a typical virtual universe has a vibrant economy, the server array 14 has functionalities that are configured to manage the economy. In particular, a universe economy management component 70 manages transactions that occur within the virtual universe between avatars. In one embodiment, the virtual universe 12 will have their own currency that users pay for with real-life money. The users can then take part in commercial transactions for their avatars through the universe economy management component 70. For example, an avatar might want to buy a surfboard so that it can go surfing. In this case, the avatar would make the purchase using the virtual universe currency to make the purchase. In some instances, the user may want to take part in a commercial transaction that benefits him or her and not their avatar. In this case, a commercial transaction management component 72 allows the user to participate in the transaction. For example, while walking around a commercial zone, an avatar may see a pair of shoes that he or she would like for themselves and not their avatar. In order to fulfill this type of transaction and others similarly related, the commercial transaction management component 72 interacts with banks 74, credit card companies 76 and vendors 78.

Although not expressly shown in FIG. 4, all of the components shown in the figure are configured to interact with each other. The components that are shown as being interconnected are illustrated in that manner to convey the close interactions that exist between these components such as the banks 74, credit card companies 76, and vendors with the commercial transaction management component 72.

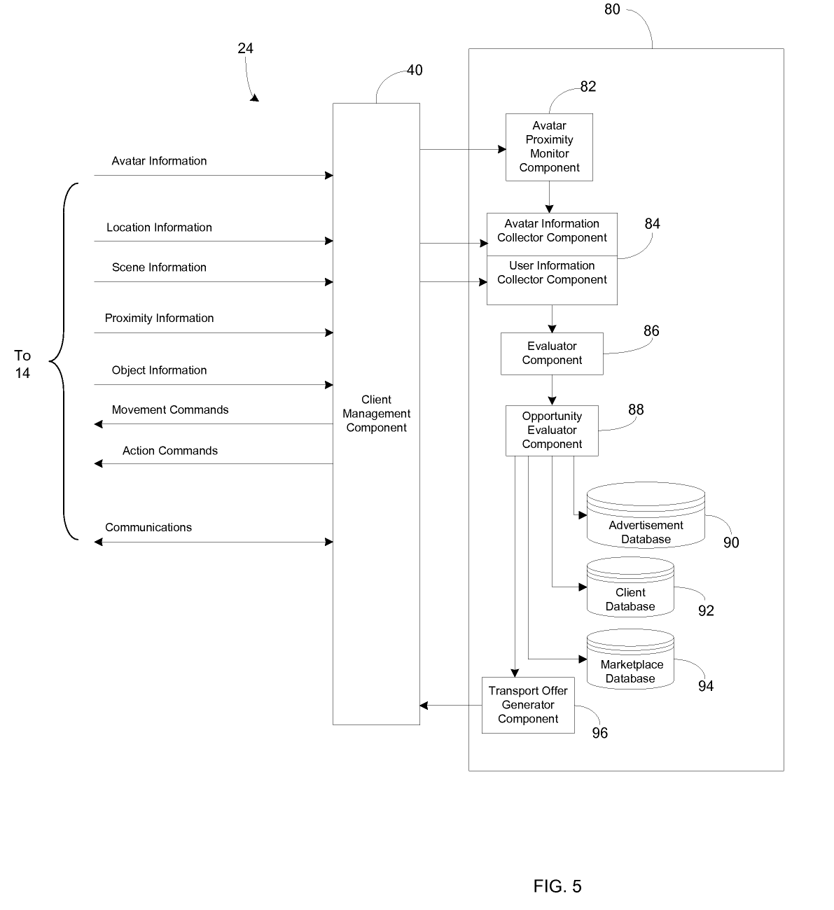

FIG. 5 shows an advertising generation tool 80 according to one embodiment of this disclosure that operates in the environment of FIG. 1. In particular, the advertising generation tool 80 provides offers of transport to avatars that are online in the virtual universe for exposure to an unsolicited advertisement. As shown in FIG. 5, in this embodiment, the advertising generation tool 80 resides on the same computer system as the virtual universe client 24 and communicates directly to the virtual universe and its denizens via the virtual universe client 24. In other embodiments, the advertising generation tool 80 might reside on the same computers as the virtual universe servers 16, or reside on separate computers in direct communication with the virtual universe servers 16.

Referring back to FIG. 5, the advertising generation tool 80 comprises an avatar proximity monitor component 82 that monitors what avatars are online in the universe and what are within close proximity to any sensors or scouting avatars, i.e., avatars used as the medium to detect the presence of “subject” or “target” avatars in pre-selected locations within the virtual universe. As used herein, being in close proximity can mean within a specific pre-determined distance of the scouting avatar, such as within virtual visual distance, or within sufficient distance to establish local avatar communications. An information collector component 84 that comprises an avatar information collector component and a user information collector component collect information from the server array 14 with respect to the avatars and the human users of the avatar. In particular, the information collector 84 collects information such as the characteristics (e.g., interests, persona, age, interactions, etc.,) of the avatars and users. The information collector may collect information about avatars and their users within proximity, or about any other avatars and their users for which information is available. This might include all currently on-line avatars, whether in proximity or not.

An evaluator component 86 evaluates the avatar and its user according to their proximity and the collector information to determine what type of advertisement if any, could be made to the user and/or avatar. In one embodiment, the evaluator 86 may utilize a set of rules to determine what type of advertisement may be pitched to the user and/or avatar. For example, if it is determined that a male avatar is within close proximity to a virtual universe landmark (e.g., a rugby field) and meets certain criteria (e.g., older than 21 years), then the evaluator may decide that an offer to transport the avatar to a designated area (e.g., “Ben's Sports Bar”) is suitable for the avatar. As another example, the evaluator component 86 may use information about avatar characteristics or user profiles to tailor the commercial experience. For instance, age information might be used to transport the user to a pharmaceutical marketplace, while national information might be used to transport the user to a travel marketplace or stock market.

An opportunity evaluator component 88 uses the information received from the evaluator component 86 and additional information stored in databases to determine whether there is an advertisement that is suitable for the user and/or avatar and whether there is a likelihood of success that the user and/or avatar would be interested in being transported to another area (e.g. a commercial zone, boutique, convention center, etc.) for exposure to an unsolicited advertisement for particular goods or services.

The databases that the opportunity evaluator component 88 uses comprises an advertisement database 90 that contains a listing advertisements, a client database 92 that contains information on both advertising clients and consumer clients. Advertising clients would be organizations seeking to advertise to suitable consumers. Consumer would include human user clients that have accepted prior offers for transport to hear advertisements and/or have made prior purchases. Opportunity evaluator component 88 also uses a marketplace database 94 that contains information on the market for the goods and services that are being offered and what consumers may have an interest in hearing about. Those skilled in the art will recognize that the opportunity evaluator component 88 may utilize other databases not shown in FIG. 5. For example, there could be an advertising campaign database that lists particular goods and services that are presently being promoted over other items sold by the vendor. Although the databases 90, 92, and 94 are shown as being separate in FIG. 5, it is possible to have all of this information stored in one database or repository. Opportunity evaluator component 88 may use customizable business logic or artificial intelligence processes to tailor advertising to the consumers available.

If the opportunity evaluator component 88 determines that there is a good opportunity to make an offer to transport an avatar to receive an unsolicited advertisement, then a transport offer generator component 96 will make that offer to the avatar and user of the avatar through a communication such as a message. The message could take a variety of forms in order to entice the avatar to accept the offer for transport. Examples of some possible messages could include an explicit offer, “Teleport to Acme Corporation Region for the best offers on Acme Corporation products”; an offer masked through intimately appealing statements, “Hi! Do you remember me? We talked last week, and I really enjoyed it. Why don't you teleport over to Paradise Island so we can get to know each other better?”; and offers masked through social group enticements, “Hey Billy Boy (avatar name)! There's a great party at Paradise Island! You HAVE to check it out!

Regardless of which message is used in the offer to transport the avatar, all of them will include a link for transporting the avatar to another location for exposure to the unsolicited advertisement. Therefore, once accepted, the avatar can transport to a virtual region such as a designated commercial zone via the capability provided by the server array 14.

Alternatively, if the opportunity evaluator component 88 determines that there is not a good opportunity to make an offer to transport an avatar to receive an unsolicited advertisement, then the transport offer generator component 96 will not make an offer. The transport offer generator component 96 will then wait until the opportunity evaluator component 88 determines that there is a good opportunity before sending a message with the offer to transport.

If the avatar does accept the offer for transport, then server array 14 would transport the avatar to the particular commercial zone designated to expose the avatar to an unsolicited advertisement. As used herein, a commercial zone could be any location in the virtual universe 12 in which advertisements and/or other offers for sale are plainly apparent to any avatar that enters that region. These regions may have names signifying their relationship with their sponsor (e.g., “Acme Corporation Region”), or relatively ambiguous names (e.g., “Paradise Island”) designed to obscure the relationship between the region and the sponsor. In addition, these regions can take on a variety of real world commercial settings such as a shopping mall, a store, a boutique or any type of locale that could entice the avatar and/or user to make a purchase.

If after being exposed to the advertisement, the avatar desires to purchase the advertised goods or services, then the avatar can purchase the items or request further information from the sponsor. Mechanisms to facilitate such a transaction could include clicking on an item or advertisement to make a purchase, providing text or speech indicating a desire to proceed further with the transaction or any other means of extending offers upon viewing virtual products or advertisements.

FIG. 5 shows some of the processing functions associated with using the advertising generation tool 80 to provide offers of transport to avatars that culminate in an unsolicited advertisement to the avatars. In this regard, each block in the tool represents a component and a process act associated with performing these functions. It should also be noted that in some alternative implementations, the acts noted in the blocks may occur out of the order noted in the figure or, for example, may in fact be executed substantially concurrently or in the reverse order, depending upon the act involved. Also, one of ordinary skill in the art will recognize that additional blocks that describe these processing acts may be added. For example, in one embodiment, it might be desirable to have a specific software component within the advertising generation tool 80 that exposes the avatar to an advertisement in the commercial region in response to the avatar accepting transport to the region. In addition, there might be another software component that enables the avatar to make a purchase of the goods or services that are subject of the advertisement or request further information.

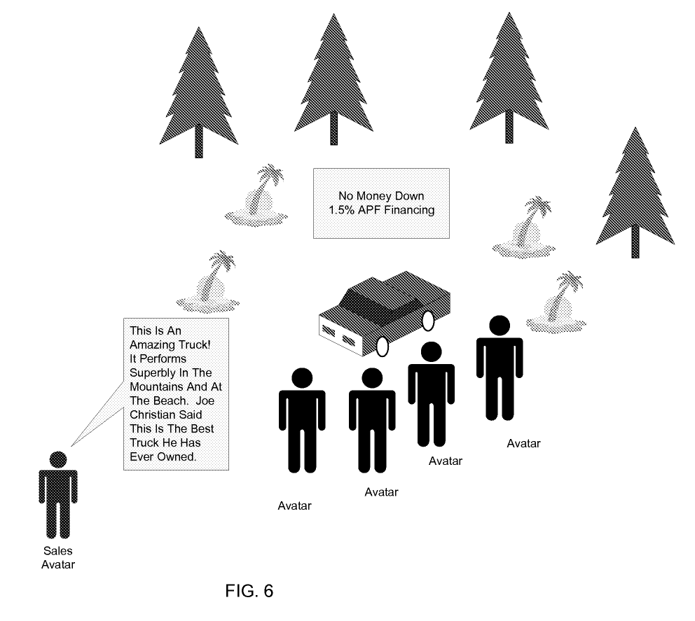

FIG. 6 shows an example of a commercial region within the virtual universe 12 that an avatar can be transported to for being exposed to an unsolicited advertisement. In FIG. 6, an avatar after accepting the offer was transported to an exotic locale having palm trees and pine trees and is exposed to an unsolicited advertisement for a pick-up truck. The avatar in FIG. 6 finds himself or herself in the locale with other avatars who have accepted an offer for transport. The unsolicited advertisement in this example contains a banner noting the low financing available if one were to buy the pick-up truck and a pitch from a sales avatar talking about the superb performance of the truck. If the avatar is interested in purchasing the truck then the avatar and/or user can make the purchase using the electronic-commerce functionalities noted above.

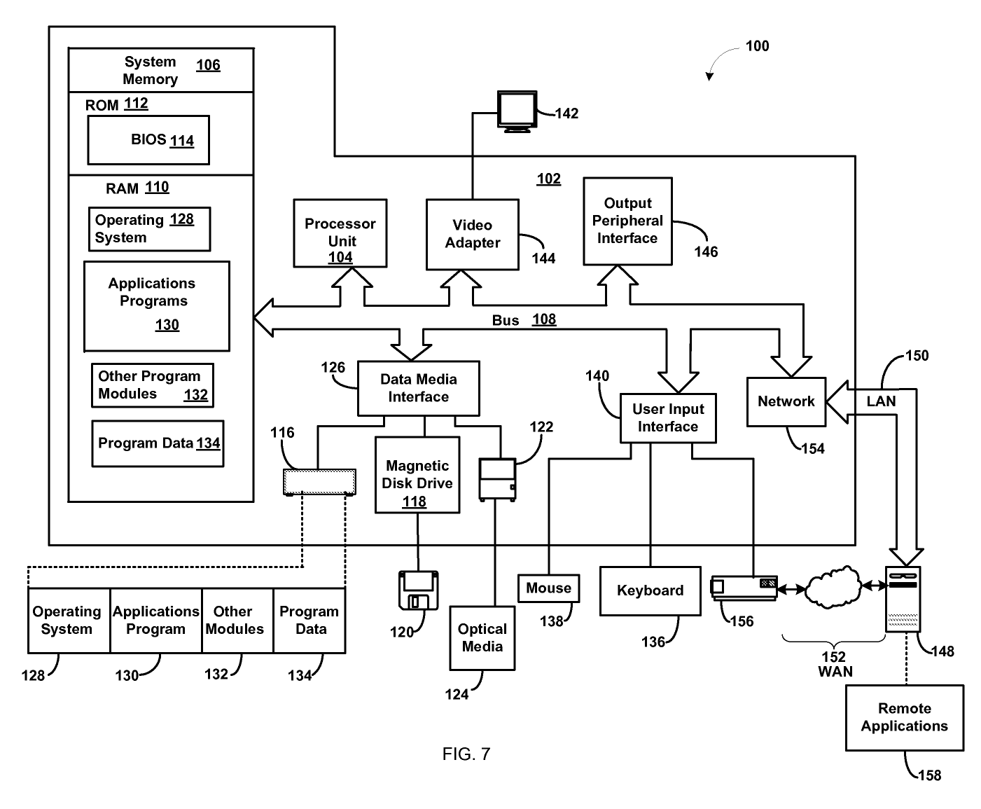

FIG. 7 shows a schematic of an exemplary computing environment in which elements of the networking environment shown in FIG. 1 may operate. The exemplary computing environment 100 is only one example of a suitable computing environment and is not intended to suggest any limitation as to the scope of use or functionality of the approach described herein. Neither should the computing environment 100 be interpreted as having any dependency or requirement relating to any one or combination of components illustrated in FIG. 7.

In the computing environment 100 there is a computer 102 which is operational with numerous other general purpose or special purpose computing system environments or configurations. Examples of well known computing systems, environments, and/or configurations that may be suitable for use with an exemplary computer 102 include, but are not limited to, personal computers, server computers, thin clients, thick clients, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The exemplary computer 102 may be described in the general context of computer-executable instructions, such as program modules, being executed by a computer. Generally, program modules include routines, programs, objects, components, logic, data structures, and so on, that performs particular tasks or implements particular abstract data types. The exemplary computer 102 may be practiced in distributed computing environments where tasks are performed by remote processing devices that are linked through a communications network. In a distributed computing environment, program modules may be located in both local and remote computer storage media including memory storage devices.

As shown in FIG. 7, the computer 102 in the computing environment 100 is shown in the form of a general-purpose computing device. The components of computer 102 may include, but are not limited to, one or more processors or processing units 104, a system memory 106, and a bus 108 that couples various system components including the system memory 106 to the processor 104.

Bus 108 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

The computer 102 typically includes a variety of computer readable media. Such media may be any available media that is accessible by computer 102, and it includes both volatile and non-volatile media, removable and non-removable media.

In FIG. 7, the system memory 106 includes computer readable media in the form of volatile memory, such as random access memory (RAM) 110, and/or non-volatile memory, such as ROM 112. A BIOS 114 containing the basic routines that help to transfer information between elements within computer 102, such as during start-up, is stored in ROM 112. RAM 110 typically contains data and/or program modules that are immediately accessible to and/or presently operated on by processor 104.

Computer 102 may further include other removable/non-removable, volatile/non-volatile computer storage media. By way of example only, FIG. 7 illustrates a hard disk drive 116 for reading from and writing to a non-removable, non-volatile magnetic media (not shown and typically called a “hard drive”), a magnetic disk drive 118 for reading from and writing to a removable, non-volatile magnetic disk 120 (e.g., a “floppy disk”), and an optical disk drive 122 for reading from or writing to a removable, non-volatile optical disk 124 such as a CD-ROM, DVD-ROM or other optical media. The hard disk drive 116, magnetic disk drive 118, and optical disk drive 122 are each connected to bus 108 by one or more data media interfaces 126.

The drives and their associated computer-readable media provide nonvolatile storage of computer readable instructions, data structures, program modules, and other data for computer 102. Although the exemplary environment described herein employs a hard disk 116, a removable magnetic disk 118 and a removable optical disk 122, it should be appreciated by those skilled in the art that other types of computer readable media which can store data that is accessible by a computer, such as magnetic cassettes, flash memory cards, digital video disks, RAMs, ROM, and the like, may also be used in the exemplary operating environment.

A number of program modules may be stored on the hard disk 116, magnetic disk 120, optical disk 122, ROM 112, or RAM 110, including, by way of example, and not limitation, an operating system 128, one or more application programs 130, other program modules 132, and program data 134. Each of the operating system 128, one or more application programs 130 other program modules 132, and program data 134 or some combination thereof, may include an implementation of the networking environment 10 of FIG. 1 including the server array 14, the virtual universe client 24 and the advertising generation tool 80.

A user may enter commands and information into computer 102 through optional input devices such as a keyboard 136 and a pointing device 138 (such as a “mouse”). Other input devices (not shown) may include a microphone, joystick, game pad, satellite dish, serial port, scanner, camera, or the like. These and other input devices are connected to the processor unit 104 through a user input interface 140 that is coupled to bus 108, but may be connected by other interface and bus structures, such as a parallel port, game port, or a universal serial bus (USB).

An optional monitor 142 or other type of display device is also connected to bus 108 via an interface, such as a video adapter 144. In addition to the monitor, personal computers typically include other peripheral output devices (not shown), such as speakers and printers, which may be connected through output peripheral interface 146.

Computer 102 may operate in a networked environment using logical connections to one or more remote computers, such as a remote server/computer 148. Remote computer 148 may include many or all of the elements and features described herein relative to computer 102.

Logical connections shown in FIG. 7 are a local area network (LAN) 150 and a general wide area network (WAN) 152. Such networking environments are commonplace in offices, enterprise-wide computer networks, intranets, and the Internet. When used in a LAN networking environment, the computer 102 is connected to LAN 150 via network interface or adapter 154. When used in a WAN networking environment, the computer typically includes a modem 156 or other means for establishing communications over the WAN 152. The modem, which may be internal or external, may be connected to the system bus 108 via the user input interface 140 or other appropriate mechanism.

In a networked environment, program modules depicted relative to the personal computer 102, or portions thereof, may be stored in a remote memory storage device. By way of example, and not limitation, FIG. 7 illustrates remote application programs 158 as residing on a memory device of remote computer 148. It will be appreciated that the network connections shown and described are exemplary and other means of establishing a communications link between the computers may be used.

An implementation of an exemplary computer 102 may be stored on or transmitted across some form of computer readable media. Computer readable media can be any available media that can be accessed by a computer. By way of example, and not limitation, computer readable media may comprise “computer storage media” and “communications media.”

“Computer storage media” include volatile and non-volatile, removable and non-removable media implemented in any method or technology for storage of information such as computer readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

“Communication media” typically embodies computer readable instructions, data structures, program modules, or other data in a modulated data signal, such as carrier wave or other transport mechanism. Communication media also includes any information delivery media.

The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above are also included within the scope of computer readable media.

It is apparent that there has been provided with this disclosure, an approach for providing unsolicited advertisements in a virtual universe through avatar transport offers. While the disclosure has been particularly shown and described in conjunction with a preferred embodiment thereof, it will be appreciated that variations and modifications can be effected by a person of ordinary skill in the art without departing from the scope of the disclosure.

In another embodiment, this disclosure provides a business method that performs the functionalities of the disclosure on a subscription, advertising, and/or fee basis. That is, a service provider could offer to generate offers of transport to avatars that are online in a virtual universe for exposure to an unsolicited advertisement. In this case, the service provider can create, deploy, maintain, support, etc., an advertising generation tool, such as tool 80 (FIG. 5) that performs the processes described in the disclosure for one or more sellers of goods and/or services. In return, the service provider can receive payment from the seller(s) under a subscription and/or fee agreement and/or the service provider can receive payment from the sale of advertising content to one or more third parties.

In still another embodiment, this disclosure provides a method for using an advertising generation tool within a computer system to generate offers of transport to avatars that are online in a virtual universe for exposure to an unsolicited advertisement. In this case, an advertising generation tool, such as tool 80 (FIG. 5), can be provided and one or more systems for performing the processes described in the disclosure can be obtained and deployed to a computer infrastructure. To this extent, the deployment can comprise one or more of (1) installing program code on a computing device, such as a computer system, from a computer-readable medium; (2) adding one or more computing devices to the infrastructure; and (3) incorporating and/or modifying one or more existing systems of the infrastructure to enable the infrastructure to perform the process actions of the disclosure.

What is claimed is:

1. A method for generating an offer of transport to an avatar that is online in a virtual universe for exposure to an unsolicited advertisement, comprising:
collecting information on the avatar; and
presenting an offer to transport the avatar to another region within the virtual universe for exposure to the unsolicited advertisement.

2. The method according to claim 1, further comprising exposing the avatar to the unsolicited advertisement in response to the avatar accepting transport.

3. The method according to claim 2, further comprising enabling the avatar to make a purchase of the goods or services that are subject of the unsolicited advertisement.

4. The method according to claim 2, further comprising enabling the avatar to make a request to receive further information that relates to the unsolicited advertisement.

5. The method according to claim 1, wherein the collecting of avatar information comprises gathering information that comprises avatar profiles, avatar interests, interactions with other avatars and proximity to regions within the virtual universe.

6. The method according to claim 1, further comprising evaluating whether the collected avatar information warrants targeting the avatar for the unsolicited advertisement;

7. The method according to claim 6, wherein the evaluating of collected avatar information comprises analyzing the collected avatar information in accordance with a plurality of advertising related information and determining whether the characteristics derived from the collected avatar information is suitable for receiving the unsolicited advertisement.

8. The method according to claim 7, further comprising selecting an advertisement targeted to the characteristics of the avatar in response to determining that the avatar is suitable for receiving the unsolicited advertisement.

9. The method according to claim 1, wherein the presenting of an offer to transport an avatar to another region within the virtual universe for exposure to the unsolicited advertisement comprises using enticements to coax the avatar to accept the offer for transport.

10. An advertising generation tool for use in a virtual universe, comprising:
an information collector component configured to collect information on an avatar that is online in the virtual universe; and
a transport offer generator component configured to present an offer to transport the avatar to another region within the virtual universe for exposure to the unsolicited advertisement.

11. The advertising generation tool according to claim 10, further comprising an avatar proximity monitor component configured to monitor avatars that are online in the virtual universe and determine avatars that are within proximity to a specified region within the virtual universe.

12. The advertising generation tool according to claim 10, wherein the information collector component is configured to gather information that comprises avatar profiles, avatar interests, interactions with other avatars and proximity to regions within the virtual universe.

13. The advertising generation tool according to claim 10, further comprising an evaluator component configured to evaluate whether the collected avatar information warrants targeting the avatar for an unsolicited advertisement

14. The advertising generation tool according to claim 13, further comprising a database comprising a plurality of advertising related information.

15. The advertising generation tool according to claim 14, wherein the evaluator component is configured to analyze the collected avatar information in accordance with the plurality of advertising related information and determine whether the characteristics derived from the collected avatar information is suitable for receiving the unsolicited advertisement.

16. The advertising generation tool according to claim 15, wherein the evaluator component is configured to select an advertisement targeted to the characteristics of the avatar in response to determining that the avatar is suitable for receiving the unsolicited advertisement.

17. The advertising generation tool according to claim 10, wherein the transport offer generator component is configured to use enticements to coax the avatar to accept the offer for transport.

18. A computer-readable medium storing computer instructions, which when executed, enables a computer system to generate an offer of transport to an avatar that is online in a virtual universe for exposure to an unsolicited advertisement, the computer instructions comprising:
collecting information on the avatar; and
presenting an offer to transport the avatar to another region within the virtual universe for exposure to the unsolicited advertisement.

19. The computer-readable medium according to claim 18, further comprising instructions for exposing the avatar to the unsolicited advertisement in response to the avatar accepting transport.

20. The computer-readable medium according to claim 19, further comprising instructions for enabling the avatar to make a purchase of the goods or services that are subject of the unsolicited advertisement.

21. The computer-readable medium according to claim 18, wherein the collecting of avatar information comprises instructions for gathering information that comprises avatar profiles, avatar interests, interactions with other avatars and proximity to regions within the virtual universe.

22. The computer-readable medium according to claim 18, further comprising instructions for evaluating whether the collected avatar information warrants targeting the avatar for the unsolicited advertisement.

23. The computer-readable medium according to claim 22, wherein the evaluating of collected avatar information comprises instructions for analyzing the collected avatar information in accordance with a plurality of advertising related information and determining whether the characteristics derived from the collected avatar information is suitable for receiving the unsolicited advertisement.

24. The computer-readable medium according to claim 23, further comprising instructions for selecting an advertisement targeted to the characteristics of the avatar in response to determining that the avatar is suitable for receiving the unsolicited advertisement.

25. The computer-readable medium according to claim 18, wherein the presenting of an offer to transport an avatar to another region within the virtual universe for exposure to the unsolicited advertisement comprises instructions for using enticements to coax the avatar to accept the offer for transport.

26. A method for exposing an avatar within a virtual universe with an unsolicited advertisement, comprising:
finding an avatar that is online in the virtual universe; and
presenting an offer to transport the avatar to another region within the virtual universe for exposure to the unsolicited advertisement.

27. A computer-readable medium storing computer instructions, which when executed, enables a computer system to generate an offer of transport to an avatar that is online in a virtual universe for exposure to an unsolicited advertisement, the computer instructions comprising:
collecting information on the avatar;
evaluating whether the collected avatar information warrants targeting the avatar for the unsolicited advertisement; and
presenting an offer to transport the avatar to another region within the virtual universe for exposure to the unsolicited advertisement.

28. A method for deploying an advertising generation tool for use in a computer system that generates unsolicited advertisements in a virtual universe, comprising:
providing a computer infrastructure operable to:
collect information on an avatar that is online in the virtual universe; and
offer to transport the avatar to another region within the virtual universe for exposure to the unsolicited advertisement.
